(19) United States
(12) Patent Application Publication
(10) Pub. No.: US 2001/0030707 A1
(43) Pub. Date: Oct. 18, 2001

(54) Digital camera

(76) Inventor: Shinichi Fujii, Osaka (JP)

Correspondence Address: Barry E. Bretschneider, Morrison & Foerster LLP, Suite 5500, 2000 Pennsylvania Avenue, N.W., Washington, DC, 20006-1888, US

(21) Appl. No.: 09/796,640

(22) Filed: Mar. 2, 2001

(30) Foreign Application Priority Data
Mar. 7, 2000 (JP) P2000-061499

(51) Int. Cl. H04N 5/228; H04N 5/225

(52) U.S. Cl. 348/335; 348/222; 348/232; 348/233

(57) ABSTRACT

When a taking lens (3) is replaced with another taking lens (3) and the another taking lens (3) is attached to a camera body (2), a detector (12) specifies the kind of the another taking lens (3) and transmits the information to a CPU (31). The CPU (31) obtains processing parameters of an image process adapted to the specified taking lens (3), which are prestored in a ROM (38). The processing parameters are set in an aperture converting and coring unit (24). The processing parameters to be set include setting of a filter size of an image filter, a gain, and a coring amount in an aperture converting process. Since the processing parameters are changed according to the kind of the taking lens (3), the resolution and noise of captured images can be maintained at a constant level. Consequently, the invention is directed to maintain resolution and noise of images captured with interchanged taking lenses at an almost constant level.

This application is based on application No. 2000-61499 filed in Japan, the contents of which are hereby incorporated by reference.

### BACKGROUND OF THE INVENTION

1. Field of the Invention

The present invention relates to a digital camera having an interchangeable taking lens, a camera body, a taking lens, and a recording medium on which a program for a digital camera is recorded.

2. Description of the Background Art

A digital camera such as a single-lens reflex digital camera in which a taking lens can be replaced with another lens and the another taking lens is attached to the camera body is known. In such a digital camera, the user selects one of a plurality of kinds of taking lenses in accordance with the subject, photographing circumstances, and the like, and attaches the selected lens to the camera body, thereby enabling an image to be obtained under desired photographing circumstances.

When the taking lens is replaced in the digital camera, however, since spatial frequency characteristics of taking lenses used for image capture are different from each other, captured images have different resolutions and noises.

It is therefore desired that, even when the taking lens is replaced with another taking lens and an image is captured with the another lens, resolutions and noises of captured images are maintained almost in a constant state.

### SUMMARY OF THE INVENTION

The invention is directed to a digital camera having an interchangeable taking lens.

According to an aspect of the invention, a digital camera comprises: a lens attachment portion to which any of a plurality of kinds of taking lenses can be attached; a detector for detecting the kind of the taking lens attached to the lens attachment portion; an image pickup device for capturing an image of a subject via the taking lens attached to the lens attachment portion; and an image processor for changing processing parameters for the image captured by the image pickup device in accordance with the kind of the taking lens detected by the detector and performing a predetermined image process on the basis of the processing parameters.

In the digital camera, therefore, the image process adapted to the taking lens is performed and resolution and noise of captured images can be maintained at a constant level.

According to one aspect, the processing parameters are conversion parameters for converting spatial frequency characteristics of the captured image, and the image process is a process for converting the spatial frequency characteristics on the basis of the conversion parameters.

Consequently, since the conversion parameters for converting spatial frequency characteristics of a captured image are changed according to the kind of the taking lens and the spatial frequency characteristics are converted on the basis of the conversion parameters, the spatial frequency characteristics of a captured image exerting an influence on the resolution and noise can be converted in accordance with the taking lens.

According to another aspect, the processing parameters in the image processor includes a filter size in a process using an image filter.

Since the filter size in the process using the image filter is changed according to the kind of the taking lens, the frequency band in which the spatial frequency characteristics are converted can be selected.

According to another aspect, the image process includes an aperture converting process, and the processing parameters in the image processor includes a gain in the aperture converting process.

Since the gain in the aperture converting process is changed according to the kind of the taking lens, the resolution of a captured image can be adjusted.

According to another aspect, the image process further includes a coring process, and the processing parameters in the image processor further includes a coring amount in the coring process.

Since the coring amount in the coring process is changed according to the kind of the taking lens, the noise of a captured image can be adjusted.

According to further another aspect, any of a telephoto lens and a wide angle lens can be attached as the taking lens to the lens attachment portion, and when the telephoto lens is detected by the detector, the image processor sets a value of the gain to be higher than that in a case where the wide angle lens is detected.

When the telephoto lens is detected, the value of the gain is set to be higher than that in a case where the wide angle lens is detected. Consequently, resolution of the image captured with the telephoto lens and that of the image captured with the wide angle lens can be made constant.

The invention is also directed to a camera body of a digital camera.

According to another aspect of the invention, the camera body comprises: a lens attachment portion to which any of a plurality of kinds of taking lenses can be attached; a detector for detecting the kind of the taking lens attached to the lens attachment portion; an image pickup device for capturing an image of a subject via the taking lens attached to the lens attachment portion; and an image processor for changing processing parameters for the image captured by the image pickup device in accordance with the kind of the taking lens detected by the detector and performing a predetermined image process on the basis of the processing parameters.

The invention is also directed to a taking lens which can be attached to a camera body of a digital camera.

According to further aspect of the invention, the taking lens comprises: a memory for storing a processing parameter in an image process performed at the time of capturing an image by using the taking lens; and a connector for electrically connecting the camera body and the memory when the taking lens is attached to the camera body.

Further, the invention is also directed to a recording medium on which an image processing program to be executed by a digital camera having an interchangeable taking lens is recorded.

Accordingly, an object of the present invention is directed that, even when the taking lens is replaced with another taking lens and an image is captured with the another lens, resolutions and noises of the captured images are maintained almost at a constant level.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an external perspective view of a digital camera;

FIG. 2 is an external view of the rear face of the digital camera;

FIG. 3 is a block diagram showing a control mechanism in the digital camera;

FIG. 4 is a diagram showing an example of spatial frequency characteristics of images captured by using different taking lenses;

FIG. 5 is a diagram showing an example of the detailed configuration of an aperture converting and coring unit;

FIG. 6 is a diagram showing signals in the units in FIG. 5;

FIG. 7 is a diagram showing the relation between inputs and outputs in a gain setting unit;

FIGS. 8A to 8C are diagrams showing an example of image filters;

FIG. 9 is a diagram showing an example of gain setting of a telephoto lens and a wide angle lens;

FIG. 10 is a diagram showing another example of the configuration of the aperture converting and coring unit;

FIG. 11 is a flowchart showing the procedure used in the digital camera; and

FIG. 12 is a diagram showing a modification of the digital camera.

### DESCRIPTION OF THE PREFERRED EMBODIMENTS

A preferred embodiment of the invention will now be described hereinafter with reference to the drawings.

1. General Configuration of Digital Camera

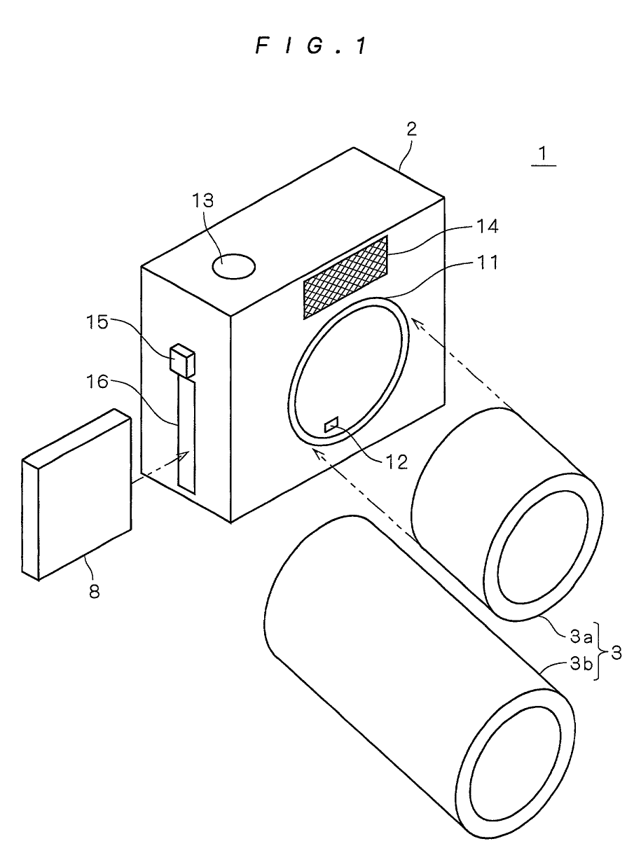

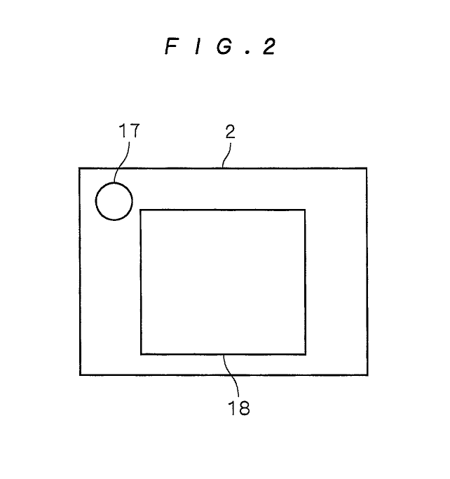

FIG. 1 is an external perspective view of a digital camera 1, and FIG. 2 is an external view showing the rear face side of the digital camera 1.

As shown in FIG. 1, in the digital camera 1, a taking lens 3 can be attached/detached to/from a camera body 2. For example, a lens having a relative shorter focal length such as a wide angle lens 3a, a lens having a relative longer focal length such as a telephoto lens 3b, or the like can be attached to the camera body 2 in place of a standard lens. The taking lens 3 is attached to the camera body 2 by the user. The user can select one of the taking lenses 3 from the standard lens, the wide angle lens 3a, telephoto lens 3b, and the like and attach the selected one to the camera body 2.

On the front face side of the camera body 2, a lens attachment portion 11 to/from which the taking lens 3 can be attached/detached, a detector 12 which is mounted on the inside of the lens attachment portion 11 and discriminates the kind of the taking lens 3 attached to the lens attachment portion 11, and a light projecting window of an electronic flash 14 for illuminating the subject are provided. On the side face of the camera body 2, a card slot 16 to which a portable recording medium 8 such as a memory card or magnetic disk card for recording captured image data, a program, and the like is inserted, and an ejection switch 15 for ejecting the recording medium 8 inserted to the card slot 16 from the camera body 2 are provided. On the top face side of the camera body 2, a shutter button 13 used by the user to perform a photographing operation is provided.

On the rear face side of the camera body 2, as shown in FIG. 2, a power button 17 for turning on/off the power of the digital camera 1 and a liquid crystal monitor 18 for displaying a captured image are provided.

In the case of photographing of the subject by using the digital camera 1, the user performs an operation of pressing the shutter button 13 at a desired timing while observing a live view displayed on the liquid crystal monitor 18. By the operation, an image (captured image) of the subject is taken as electric data, the electric data is subjected to a predetermined image process, and the resultant image data is stored in the recording medium 8.

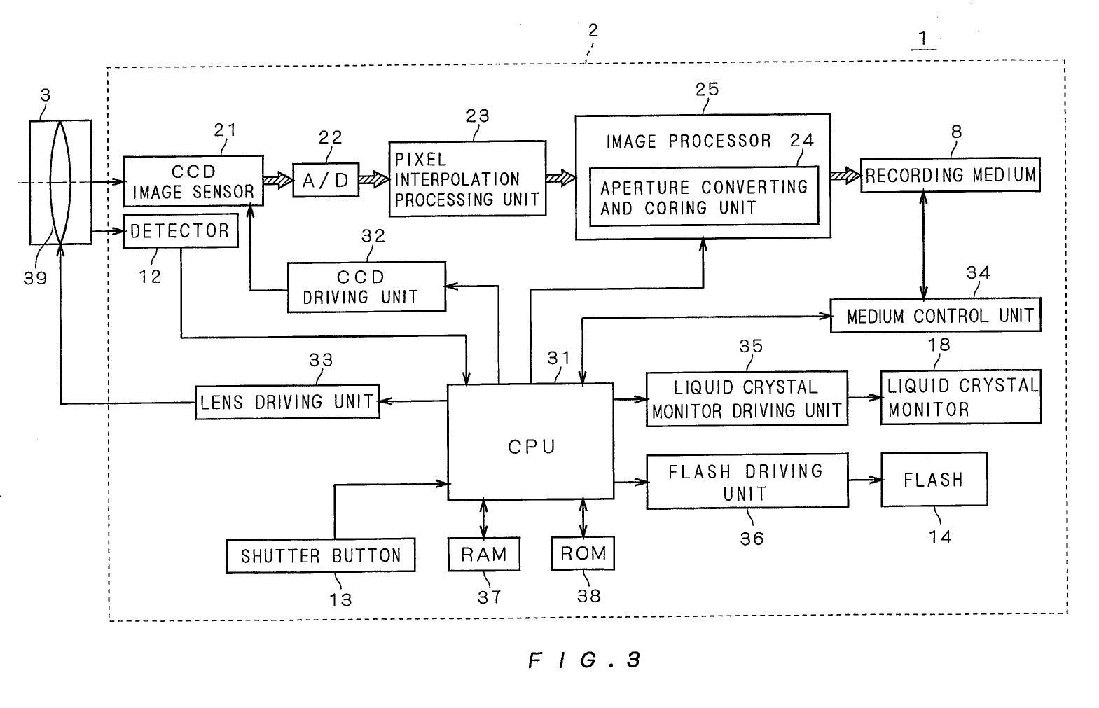

FIG. 3 is a block diagram showing the control mechanism in the digital camera 1. Hatched arrows in FIG. 3 show the flow of the image data, and solid-line arrows show the flow of control data.

As shown in FIG. 3, in the camera body 2, light from the subject is detected through the taking lens 3 by a CCD image sensor 21 and is photo-electronic-converted to a luminance signal of the subject. The CCD image sensor 21 has an image-pickup face in which a plurality of pixels are arranged two-dimensionally, generates the luminance signal of a corresponding part of the subject on a pixel-by-pixel basis, and supplies the luminance signal to an A/D converter 22.

When the luminance signal of each pixel is received, the A/D converter 22 converts the luminance signal into digital data of, for example, eight bits. As a result, the image data of the subject obtained by the CCD image sensor 21 is obtained as digital data.

The digital image data is led to a pixel interpolation processing unit 23. In the pixel interpolation processing unit 23, a process of coloring an image so that the pixels have color components of, for example, R (red), G (green), and B (blue) is performed. For example, in the case where the image-pickup face of the CCD image sensor 21 has a pixel array associated with the color components in the Bayer array, the luminance component of one of the RGB colors corresponding to the Bayer array is detected in each pixel. By performing the pixel interpolation process so that the pixels have data of all the color components, a color image is obtained.

The image data subjected to the coloring process is led to an image processing unit 25. In the image processing unit 25, various image processes such as color correcting process, outline emphasizing process, gradation correcting process, aspect ratio converting process, and the like are performed. Among them, the outline emphasizing process is an important image process for adjusting the resolution and noise of the captured image. The image processing unit 25 is provided with an aperture converting and coring unit 24 for performing an aperture converting process and a coring process to carry out the outline emphasizing process.

The aperture converting process is a process for adjusting the resolution of a captured image by performing a predetermined process on image data by using an image filter. The coring process is a process for adjusting noise in a captured image.

After completion of the image process in the image processing unit 25, the image data is stored in the recording medium 8.

On the inside the camera body 2, a CPU (Central Processing Unit) 31 is provided. The CPU 31 is electrically connected to the detector 12, a CCD driving unit 32, a lens driving unit 33, the image processing unit 25, a medium control unit 34, a liquid crystal monitor driving unit 35, a flash driving unit 36, a RAM (Random Access Memory) 37, a ROM (Read-Only Memory) 38, and the shutter button 13.

The CPU 31 realizes an automatic focusing function by outputting a control signal to the lens driving unit 33 to drive a lens 39 itself in the taking lens 3. When a trigger generated by the press of the shutter button 13 is detected, the CPU 31 transmits a control signal to the CCD driving unit 32. In such a manner, the CCD driving unit 32 allows charge storage (integration) in the CCD image sensor 21 to be started.

The CPU 31 also supplies a control signal for recording/reading the image data to the medium control unit 34. By the control signal, the image data subjected to the predetermined image process in the image processing unit 25 is recorded to the recording medium 8.

The CPU 31 also sends a control signal to the liquid crystal monitor driving unit 35 so that the liquid crystal monitor driving unit 35 displays the captured image on the liquid crystal monitor 18 disposed on the rear face side of the camera body 2.

The CPU 31 also supplies a control signal to the flash driving unit 36 so that the flash driving unit 36 allows the flash 14 to emit light and the subject is irradiated with the light.

The detector 12 is constructed to detect the kind of the taking lens 3 attached to the camera body 2 when the power button 17 is depressed and the digital camera 1 starts. As a specific detecting method by the detector 12, a method of obtaining a lens code or the like indicative of the kind of the taking lens 3 from a CPU (not shown) or the like provided on the inside of the taking lens 3, and specifying the kind of the taking lens 3 from the lens code can be applied. Another method of reading a mark or the like formed in a predetermined position of the taking lens 3 by the detector 12 to thereby identify the lens code of the taking lens 3 and specifying the kind of the taking lens 3 from the lens code can be also applied.

The kind of the taking lens 3 detected by the detector 12 is notified to the CPU 31. Also in the case where the detector 12 cannot properly detect the kind of the taking lens 3, the result is notified to the CPU 31. It is also possible to construct in such a manner that the detector 12 can detect the attachment/detachment of the taking lens 3 and, each time the taking lens 3 is attached, the kind of the taking lens 3 is detected.

The RAM 37 is a memory for holding temporary data in the control process of the CPU 31, image data, and the like.

In the ROM 38, the processing parameters in the image processing unit 25 according to the kinds of the taking lenses 3 are stored. In accordance with the result of detection of the detector 12, the CPU 31 obtains the processing parameters according to the taking lens 3 from the ROM 38 and supplies the processing parameters to the image processing unit 25.

A program to be executed by the CPU 31 and the like is also stored in the ROM 38. When the power is turned on, the CPU 31 reads the program from the ROM 38 and executes it to thereby control the components in the camera body 2.

In the case of photographing the subject a plurality of frames by using the digital camera 1 constructed as described above, for example, when the taking lens 3 is changed from the wide angle lens 3a to the telephoto lens 3b between the frames, to make the resolution and noise of an image captured by using the wide angle lens 3a and those of an image captured by using the telephoto lens 3b coincide with each other, the CPU 31 changes the processing parameters in the image processing unit 25 on the image data in accordance with the taking lens 3.

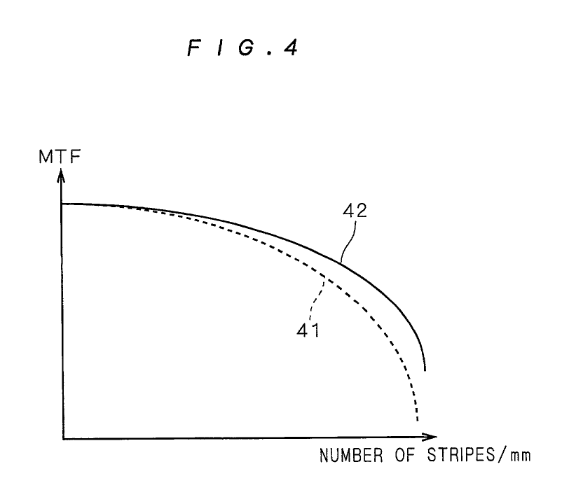

FIG. 4 is a diagram showing an example of the spatial frequency characteristics of images captured by photographing the subject with the wide angle lens 3a and the telephoto lens 3b. A characteristic curve 42 shown by the solid line denotes the spatial frequency characteristic of an image obtained with the wide angle lens 3a. A characteristic curve 41 shown by the broken line denotes the spatial frequency characteristic of an image captured with the telephoto lens 3b. The horizontal axis denotes the number of stripes in a black-and-white pattern in one millimeter, and the vertical axis denotes MTF (Modulation Transfer Function).

As shown in FIG. 4, when photographing is conducted while changing the lens 3, the spatial frequency characteristics of images captured by the photographing are different from each other. Specifically, the image captured with the wide angle lens 3a and that captured with the telephoto lens 3b have quite different spatial frequency characteristics as shown by the characteristic curves 41 and 42. The resolutions and noises in the images are consequently different from each other. That is, in the digital camera 1, by performing a predetermined image process and the like on the image data obtained by photographing, the image data to be recorded on the recording medium 8 is generated. When the image process under the same conditions is performed before and after the taking lens 3 is changed, the spatial frequency characteristics are different according to the taking lens 3. The resolutions and noises of the images are consequently different from each other.

In the preferred embodiment, therefore, by changing the processing parameters in the image processing unit 25, particularly, the processing parameters in the aperture converting and coring unit 24 in accordance with the taking lens 3 used at the time of photographing, the spatial frequency characteristics of a captured image are converted, so that even when images are captured while changing the taking lens 3, the spatial frequency characteristics in the images become constant.

2. Aperture Converting and Coring Unit

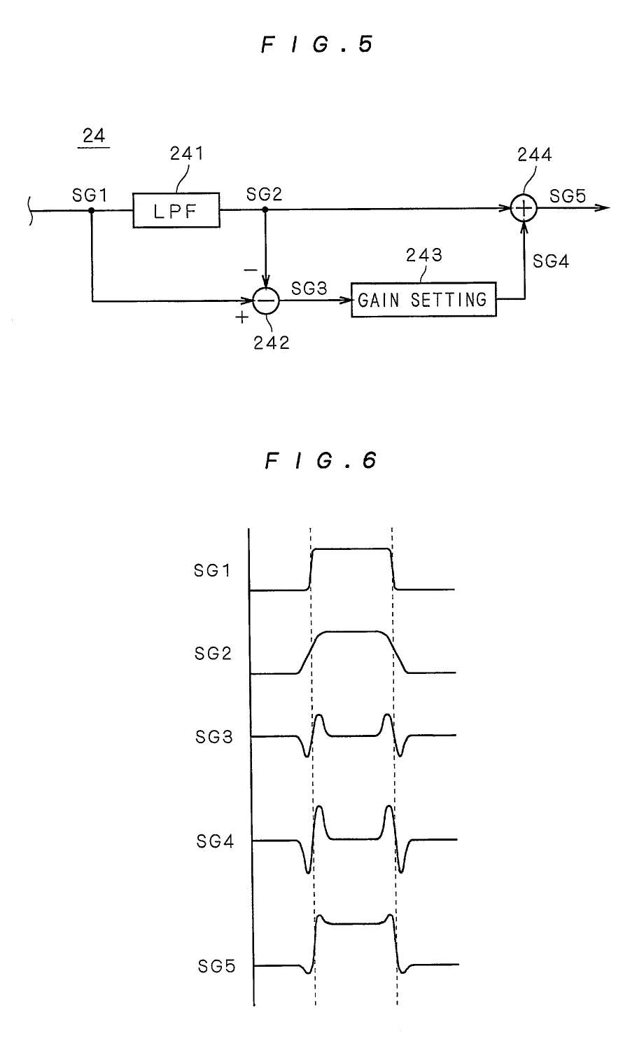

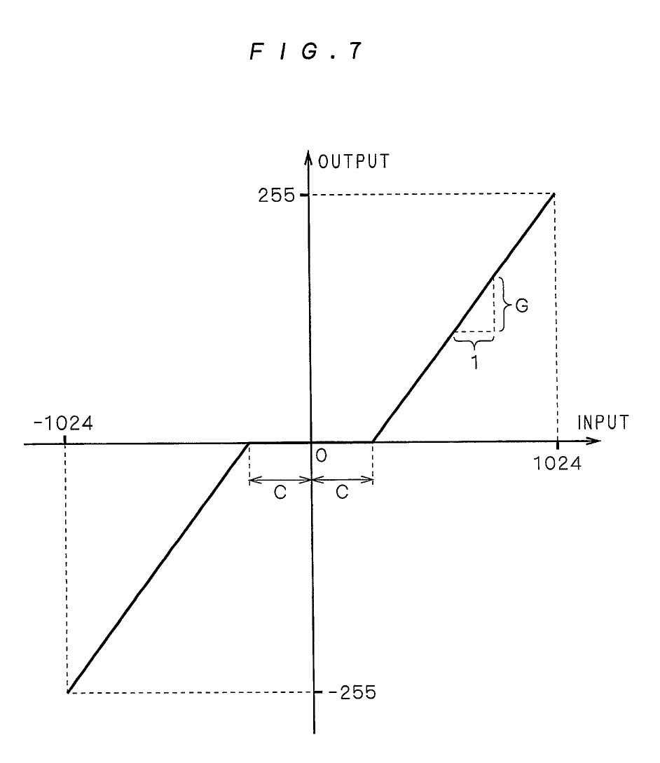

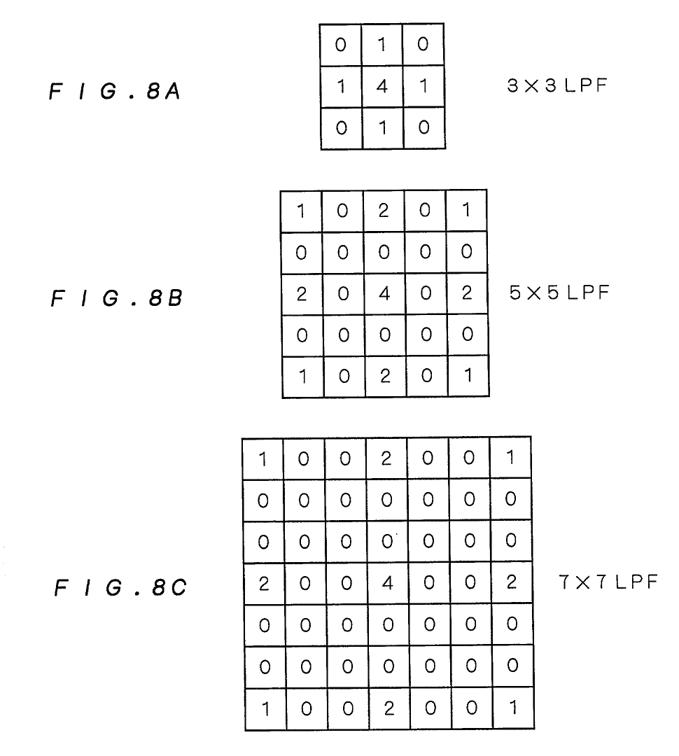

FIG. 5 is a diagram showing an example of the detailed configuration of the aperture converting and coring unit 24. FIG. 6 is a diagram showing signals SG1 to SG5 in the units in FIG. 5.

As shown in FIG. 5, the aperture converting and coring unit 24 includes a low pass filter processing unit 241, a subtracter 242, a gain setting unit 243, and an adder 244.

In the low pass filter processing unit 241, a process for smoothing an image is performed by using a low pass filter of n×n (where n is an arbitrary odd number) as an image filter. Since the image area to be smoothed is determined according to the size of the image filter used in the low pass filter processing unit 241, by changing the size of the image filter, a spatial frequency band to be processed by the aperture converting and coring unit 24 can be changed.

When the signal SG1 supplied to the aperture converting and coring unit 24 is passed through the low pass filter processing unit 241, a filtered signal SG2 is obtained. The signal SG2 is led to the subtracter 242 and the adder 244. In the subtracter 242, the signal SG2 is subtracted from the input signal SG1, thereby generating a signal SG3.

As shown in FIG. 6, when the process using the low pass filter is performed on the input signal SG1, the signal SG2 in which the image component is smoothed is generated. When the signal SG2 is subtracted from the signal SG1, the signal SG3 in which the edge components of the signal SG1 are extracted is derived. The signal SG3 in which the edge components of the signal SG1 are extracted is supplied to the gain setting unit 243.

The gain setting unit 243 receives the signal SG3 and generates the output signal SG4 with reference to the data converting table.

FIG. 7 is a diagram showing the relation between the input signal SG3 and the output signal SG4 in the gain setting unit 243.

As shown in FIG. 7, when the absolute value of the input signal SG3 is within the range of a coring amount C, the output signal SG4 is zero. The signal SG3 is a signal obtained by extracting the edge components of the signal SG1 supplied to the aperture converting and coring unit 24. Since the extraction of the edge components corresponds to extraction of high frequency components of an image, a noise component included in the image is also extracted. Generally, the noise component is reflected in the signal SG3 as a value relatively smaller than the effective edge component. Consequently, the gain setting is performed in such a manner that the signal component in the signal SG3 which is within the coring amount C is regarded as a noise component and the noise component is not reflected in the output signal SG4. That is, by using the coring amount C, the noise component can be eliminated. By fluctuating the coring amount C, the degree of eliminating noise fluctuates. Thus, the noise in the captured image can be adjusted.

As shown in FIG. 7, when the absolute value of the input signal SG3 is larger than the range specified by the coring amount C, there is a relation such that, as the absolute value of the input signal SG3 increases, the absolute value of the output signal SG4 increases at an increasing ratio (gradient) based on the gain G. The gain G is an index to show the degree of reflecting an effective edge component included in the signal SG3 into the output signal SG4. The higher the gain G is, the more the edge component is strongly (largely) reflected in the output signal SG4. On the contrary, the lower the gain G is, the less the edge component is reflected in the output signal SG4. Generally, when the edge component of an image is reflected strongly, an image becomes visually sharp, so that the resolution can be improved. On the other hand, when the edge component is weakly reflected, the image is not visually sharp, so that the resolution deteriorates. By fluctuating the gain G, therefore, the degree of the edge component can be adjusted. As a result, the resolution in the captured image can be adjusted.

When the signal conversion is performed in the input/output relation as shown in FIG. 7 in the gain setting unit 243, the signal SG4 as shown in FIG. 6 is generated. The signal SG4 is led to the adder 244.

In the adder 244, the signal SG2 subjected to the filtering process in the low pass filter processing unit 241 and the signal SG4 generated by the gain setting unit 243 are added to each other, thereby generating the signal SG5. As shown in FIG. 6, the signal SG5 is a signal obtained by emphasizing the edge portion of the signal SG1 to be supplied to the aperture converting and coring unit 24, thereby realizing adjustment of the resolution and noise of the image of the input signal SG1.

In the case of adding the signal SG4 to the signal SG1, there is a problem that the noise component included in the signal SG1 is reflected as it is in the output signal SG5. In the configuration example of FIG. 5, the signal SG4 is added to the signal SG2 subjected to the filtering process by the low pass filter, so that the output signal SG5 obtained by reducing the noise component included in the signal SG1 can be generated.

The filtering process performed by using the image filter having the filter size of (n×n) corresponds to conversion of, what is called, the aperture size at the time of input of an image. Consequently, such a process is called an aperture converting process. Since the noise component is eliminated by the coring amount C in the gain setting unit 243, such a process is called the coring process.

In response to the control instruction from the CPU 31, according to the kind of the taking lens 3 the aperture converting and coring unit 24 constructed as described above changes the filter size of the image filter (low pass filter) applied in the low pass filter processing unit 241 and the coring amount C and the gain G in the gain setting unit 243.

FIGS. 8A to 8C are diagrams showing an example of the image filters applied in the low pass filter processing unit 241. FIG. 8A shows a (3×3) image filter, FIG. 8B shows a (5×5) image filter, and FIG. 8C illustrates a (7×7) image filter. There is no problem when different values are adopted as the filter component values (coefficients) indicated in the image filters.

The image filter shown in FIG. 8A has the smallest filter size in the three image filters shown in FIGS. 8A to 8C and has an action of extracting the edge components in a high frequency domain and eliminating noise components in the domain.

The image filter shown in FIG. 8B has an action of extracting the edge components in an intermediate frequency domain and eliminating the noise components in the domain.

Further, the image filter shown in FIG. 8C has the largest filter size among the three image filters of FIGS. 8A to 8C and has an action of extracting the edge components in a low frequency domain and eliminating the noise components in the domain.

By changing the filter size of the image filter, therefore, the spatial frequency band to be processed when the spatial frequency characteristics of an image are converted can be changed.

The image filters shown in FIGS. 8A to 8C are prestored in the ROM 38 in the camera body 2 in association with the kinds of the taking lenses 3. The image filter is set in such a manner that the CPU 31 obtains one of the image filters from the ROM 38 on the basis of the result of detection of the taking lens 3 by the detector 12 and supplies it to the aperture converting and coring unit 24.

A plurality of kinds of the input/output relations specified by the coring amount C and the gain G in the gain setting unit 243 are also prestored in the ROM 38 in accordance with the kinds of the taking lenses 3. The input/output relation is set in the gain setting unit 243 in such a manner that the CPU 31 obtains one of the input/output relations from the ROM 38 on the basis of the result of detection of the taking lens 3 by the detector 12 and supplies it to the aperture converting and coring unit 24.

As described above, by changing the processing parameters in the aperture converting and coring unit 24 in accordance with the kind of the taking lens 3, the resolution and noise of the captured image can be adjusted. Thus, a plurality of images captured with the different taking lenses 3 can have uniform resolution and noise.

For example, as understood from the spatial frequency characteristic shown in FIG. 4, generally, when the wide angle lens 3a is used as the taking lens 3, the resolution of the captured image is high. In contrast, when the telephoto lens 3b is used as the taking lens 3, the resolution of the captured image is low. When the detector 12 detects the lens code of the telephoto lens 3b, therefore, the CPU 31 sets the gain G in the gain setting unit 243 so as to be higher than that of the wide angle lens 3a. On the contrary, when the detector 12 detects the lens code of the wide angle lens 3a, the CPU 31 sets the gain G in the gain setting unit 243 so as to be lower than that of the telephoto lens 3b.

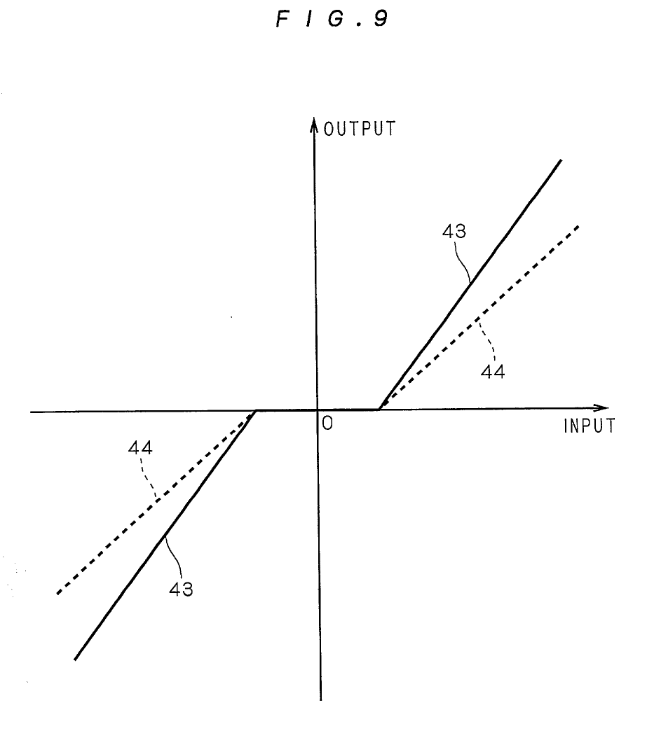

FIG. 9 is a diagram showing the conversion characteristic in the gain setting unit 243 of this example. As shown in FIG. 9, when the taking lens 3 is the telephoto lens 3b, a conversion characteristic 43 is selected as the input/output relation in the gain setting unit 243. When the taking lens 3 is the wide angle lens 3a, a conversion characteristic 44 is selected as the input/output relation in the gain setting unit 243. As a result, the resolution of the image captured with the wide angle lens 3a can be reduced, the resolution of the image captured with the telephoto lens 3b can be improved, and the resolutions of the images captured with the wide angle lens 3a and the telephoto lens 3b can be made coincide with each other.

There is also a case that the detector 12 cannot detect the kind of the taking lens 3. For example, there is the possibility that the taking lens 3 does not have the lens code. There is also a case that although the taking lens 3 has the lens code, the processing parameters corresponding to the lens code are not preset in the ROM 38.

In such a case, the processing parameters in the aperture converting and coring unit 24 cannot be set. In the preferred embodiment, therefore, default values of the processing parameters to be set when the detector 12 cannot detect the kind of the taking lens 3 are prestored in the ROM 38. When the detector 12 cannot specify the kind of the taking lens 3, the CPU 31 obtains the default values of the processing parameters from the ROM 38 and set as the processing parameters in the aperture converting and coring unit 24. Consequently, even when the detector 12 cannot properly detect the taking lens 3, the image process on the captured image data can be progressed, so that the captured image can be recorded on the recording medium 8.

When the camera body 2 having the function of setting such default values is realized, even when a matter other than the taking lens 3 is attached, the image capturing operation can be properly performed. A matter other than the taking lens 3 is, for example, a microscope. By attaching a microscope to the lens attachment portion 11 of the camera body 2, an image of a small area acquired with the microscope can be recorded on the recording medium 8.

The default values of the processing parameters are, preferably, set so as not to excessively convert the spatial frequency characteristics of a captured image. Consequently, the minimum coring amount C and the minimum gain G are set as default values. By using the minimum coring amount C and the minimum gain G as default values (for example, it is preferable to set each of the coring amount and the gain so as to be about the half of each of the coring amount and the gain in the case of the wide angle lens), excessive noise elimination can be prevented and excessive edge emphasis can be also prevented. Thus, the spatial frequency characteristics can be prevented from being converted larger than a predetermined range.

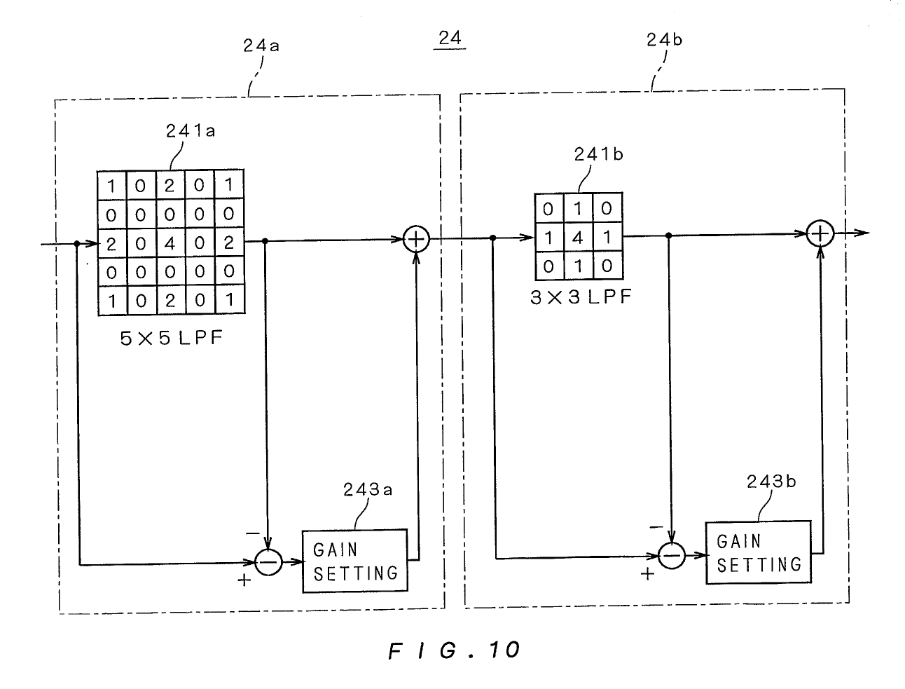

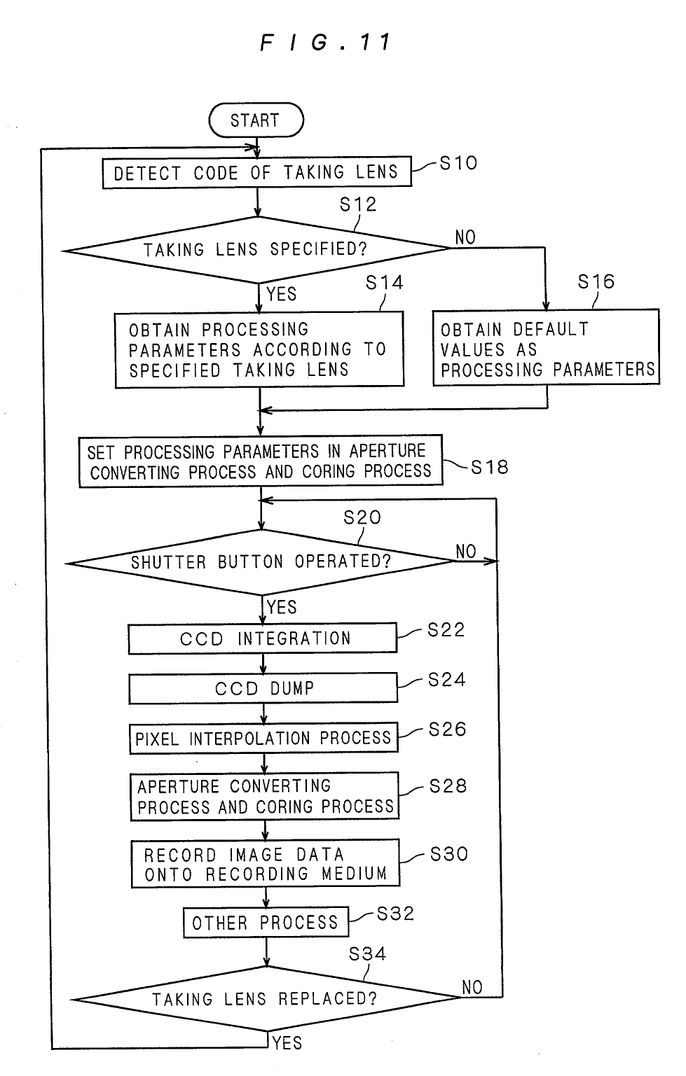

Another example of the configuration of the aperture converting and coring unit 24 will now be described. FIG. 10 is a diagram showing another example of the configuration of the aperture converting and coring unit 24.

As shown in FIG. 10, the aperture converting and coring unit 24 is obtained by connecting processing units shown in FIG. 5 at multiple stages. Specifically, the aperture converting and coring unit 24 is constructed by a first processing unit 24a and a second processing unit 24b.

In the first processing unit 24a, the image filter of the (5×5) filter size in the low pass filter processing unit 241 a, which is an image filter of the intermediate frequency domain is applied. In the first processing unit 24a, a process in the intermediate frequency domain is performed.

In the second processing unit 24b, the image filter of the (3×3) filter size is applied in the low pass filter processing unit 241b, which is an image filter of the high frequency domain. In the second processing unit 24b, a process in the high frequency domain is performed.

By connecting the processing units shown in FIG. 5 at multiple stages as described above, the processes in the plurality of frequency domains can be performed. In the configuration example, the coring amount C and the gain G in the gain setting unit 243a in the first processing unit 24a and those in the gain setting unit 243b in the second processing unit 24b are changed according to the kind of the taking lens 3.

3. Procedure in Digital Camera 1

The procedure used in the digital camera 1 will now be described. FIG. 11 is a flowchart showing the procedure used in the digital camera 1.

First, when the power button 17 is depressed by the user, the detector 12 detects the lens code of the taking lens 3 attached to the camera body 2 (step S10). The result of the detection by the detector 12 is transmitted to the CPU 31.

The CPU 31 determines whether the kind of the taking lens 3 has been specified by the detector 12 or not (step S12). When the kind of the taking lens 3 attached to the camera body 2 has been specified, the program advances to step S14. When it is not specified, the program advances to step S16.

In step S14, the CPU 31 accesses the ROM 38 to obtain the processing parameters according to the kind of the taking lens 3 specified by the detector 12.

On the other hand, in step S16, the CPU 31 accesses the ROM 38 to obtain predetermined default values as processing parameters in the aperture converting and coring unit 24.

The program advances to step S18 where the processing parameters obtained in step S14 or S16 are set as processing parameters in the aperture converting and coring unit 24.

By the processes in steps S10 to S18, the operation of setting the processing parameters in the image processing unit 25 according to the kind of the taking lens 3 is completed, thereby completing the preparation for image capture.

Whether the operation of depressing the shutter button 13 by the user has been performed or not is determined and a standby mode is set until the shutter button 13 is depressed (step S20).

When the shutter button 13 is operated, the CPU 31 sends a control signal to the CCD driving unit 32 to start the integration (exposure) of the CCD image sensor 21 (step S22). After elapse of predetermined integration time, the CCD driving unit 32 sequentially outputs luminance signals of respective pixels from the CCD image sensor 21 to the A/D converter 22 (step S24). The image data is outputted in color from the pixel interpolation processing unit 23, and the color captured image data is transferred to the image processing unit 25 (step S26).

In step S28, the aperture converting and coring process is performed on the basis of the processing parameters set by the CPU 31. Since the processing parameters according to the kind of the taking lens 3 are set except for the case where the default values are set, the resolution and noise of an image obtained as a result of the aperture converting and coring process is at a constant level.

The image data captured as a result is recorded on the recording medium 8 (step S30) and, after that, other processes which are not related to the image process are carried out (step S32).

Subsequently, the CPU 31 determines whether the taking lens 3 has been replaced or not (step S34). When the taking lens 3 has been replaced with another taking lens 3, the program returns to step S10 to again detect the lens code of the new taking lens 3. On the other hand, when the taking lens 3 has not been replaced, the program returns to step S20 to enter an image capture standby mode.

This is the end of the procedure in the digital camera 1. As shown in the procedure, when the kind of the taking lens 3 can be specified, the aperture converting and coring process is performed with the processing parameters adapted to the taking lens 3. Consequently, the resolution and noise of an image obtained finally is constant irrespective of the taking lenses used at the time of photography.

Also in the case where the kind of the taking lens 3 has not been specified, by setting the default values as processing parameters and performing the aperture converting and coring process with the default values, the image capturing operation can be performed.

The procedure as described above is carried out in such a manner that the CPU 31 in the camera body 2 reads and executes the program prestored in the ROM 38. In the digital camera 1, however, in some cases, the processing program is changed after that. In the case where the ROM 38 takes the form of an EEPROM or the like, by recording a processing program as described above onto the recording medium 8, the processing program in the ROM 38 can be changed. Specifically, it is also possible to construct so that the recording media 8 is inserted to the camera body 2 and the CPU 31 reads a program recorded on the recording medium 8 and updates the program in the ROM 38 with the read program. By allowing the program of the digital camera 1 to be updated via the recording medium 8, the user himself/herself can update the program.

Since the number of kinds of the taking lenses 3 may increase later, in association with an increase in the number of kinds of the taking lenses 3, the processing parameters in the ROM 38 can be added. In this case as well, by recording the processing parameters to be added in the recording medium 8, the CPU 31 can read the processing parameters and add them to the processing parameters in the ROM 38. By allowing the processing parameters in the image process to be added via the recording medium 8, the user himself/herself can add the processing parameters.

4. Modifications

Although the preferred embodiment of the invention has been described above, the invention is not limited to the foregoing preferred embodiment.

In the preferred embodiment, the example of changing the processing parameters in the aperture converting and coring process unit 24 in accordance with the kind of the taking lens 3 has been described above. Other image processing parameters in the image processing unit 25 can be also changed.

Although the case where the processing parameters according to the kind of the taking lens 3 are stored in the ROM 38 on the camera body 2 side has been described above as an example, the processing parameters may be stored in the taking lens 3 side. The configuration example will now be described hereinbelow.

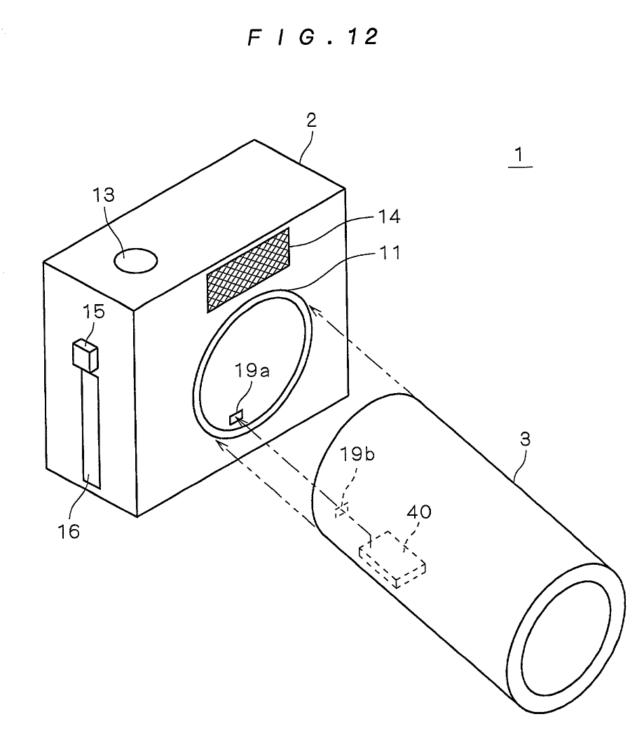

FIG. 12 is a diagram showing the digital camera 1 of the configuration example. In FIG. 12, the same reference numerals are designated to the same members as those described above and their description will not be repeated.

On the inside of the lens attachment portion 11 in the camera body 2, a connector 19a is provided. On the other hand, the taking lens 3 has a connector 19b to be connected to the connector 19a and a ROM 40 for recording processing parameters (that is, processing parameters adapted to its lens) in an image process at the time of capturing an image with the taking lens 3. The connector 19b and the ROM 40 are electrically connected to each other.

When the taking lens 3 is attached to the lens attachment portion 11, it is constructed so that the connectors 19a and 19b are connected to each other to thereby electrically connecting the camera body 2 and the taking lens 3 to each other. In the case of the configuration example, it is therefore unnecessary to provide the detector 12 on the camera body 2 side. The CPU 31 provided on the inside of the camera body 2 directly accesses the ROM 40 in the taking lens 3, thereby enabling the processing parameters adapted to the taking lens 3 to be obtained. By storing the processing parameters adapted to the lens on the inside of the taking lens 3, effects such that the data amount of the ROM 38 in the camera body 2 can be reduced and it becomes unnecessary to add the processing parameters in the ROM 38 at a later time are also displayed.

Although the example of processes using the low pass filter in the aperture converting and coring unit 24 has been described in the foregoing preferred embodiment, it is also possible to construct that the edge component is directly extracted by using a differential filter.

Although the internal components of the camera shown in FIGS. 3, 5, 10 and the like have been described as each being provided as an independent unit, they are not limited as such. For instance, the internal components may share at least part of each other. Alternatively, at least part of the function of each internal component may be achieved by a software in the CPU 31, or at least one of the internal components may be the function of a software in the CPU 31.

While the invention has been shown and described in detail, the foregoing description in all aspects illustrative and not restrictive. It is therefore understood that numerous modifications and variations can be devised without departing from the scope of the invention.

What is claimed is:

1. A digital camera having an interchangeable taking lens, comprising:
a lens attachment portion to which any of a plurality of kinds of taking lenses can be attached;
a detector for detecting the kind of the taking lens attached to said lens attachment portion;
an image pickup device for capturing an image of a subject via the taking lens attached to said lens attachment portion; and
an image processor for changing processing parameters for the image captured by said image pickup device in accordance with the kind of said taking lens detected by said detector and performing a predetermined image process on the basis of the processing parameters.

2. The digital camera according to claim 1, wherein
said processing parameters are conversion parameters for converting spatial frequency characteristics of said captured image, and
said image process is a process for converting said spatial frequency characteristics on the basis of said conversion parameters.

3. The digital camera according to claim 2, wherein
said processing parameters in said image processor includes a filter size in a process using an image filter.

4. The digital camera according to claim 2, wherein
said image process includes an aperture converting process, and
said processing parameters in said image processor includes a gain in said aperture converting process.

5. The digital camera according to claim 3, wherein
said image process includes an aperture converting process, and
said processing parameters in said image processor further includes a gain in said aperture converting process.

6. The digital camera according to claim 4, wherein
said image process further includes a coring process, and
said processing parameters in said image processor further includes a coring amount in said coring process.

7. The digital camera according to claim 5, wherein
said image process further includes a coring process, and
said processing parameters in said image processor further includes a coring amount in said coring process.

8. The digital camera according to claim 4, wherein
any of a first lens having a relative longer focal length and a second lens having a relative shorter focal length can be attached as said taking lens to said lens attachment portion, and
when said first lens is detected by said detector, said image processor sets a value of said gain to be higher than a case where said second lens is detected.

9. The digital camera according to claim 5, wherein
any of a first lens having a relative longer focal length and a second lens having a relative shorter focal length can be attached as said taking lens to said lens attachment portion, and
when said first lens is detected by said detector, said image processor sets a value of said gain to be higher than a case where said second lens is detected.

10. The digital camera according to claim 6, wherein
any of a first lens having a relative longer focal length and a second lens having a relative shorter focal length can be attached as said taking lens to said lens attachment portion, and
when said first lens is detected by said detector, said image processor sets a value of said gain to be higher than a case where said second lens is detected.

11. The digital camera according to claim 7, wherein
any of a first lens having a relative longer focal length and a second lens having a relative shorter focal length can be attached as said taking lens to said lens attachment portion, and
when said first lens is detected by said detector, said image processor sets a value of said gain to be higher than a case where said second lens is detected.

12. The digital camera according to claim 1, wherein
when the kind of said taking lens cannot be detected by said detector, said image processor sets a predetermined default value as said processing parameter.

13. A camera body of a digital camera comprising:
a lens attachment portion to which any of a plurality of kinds of taking lenses can be attached;
a detector for detecting the kind of the taking lens attached to said lens attachment portion;
an image pickup device for capturing an image of a subject via the taking lens attached to said lens attachment portion; and
an image processor for changing processing parameters for the image captured by said image pickup device in accordance with the kind of said taking lens detected by said detector and performing a predetermined image process on the basis of the processing parameters.

14. A taking lens which can be attached to a camera body of a digital camera, comprising:
a memory for storing a processing parameter in an image process performed at the time of capturing an image by using said taking lens; and
a connector for electrically connecting said camera body and said memory when said taking lens is attached to said camera body.

15. A recording medium on which an image processing program to be executed by a digital camera having an interchangeable taking lens is recorded, wherein
said image processing program is a program for allowing said digital camera to execute:
changing a processing parameter for an image captured by said image pickup device in accordance with a kind of said taking lens; and
performing a predetermined image process on the basis of said processing parameter.
